(19) United States
(12) Patent Application Publication
(10) Pub. No.: US 2024/0412639 A1
(43) Pub. Date: Dec. 12, 2024

(54) DISPATCHING AUTONOMOUS VEHICLES TO PROVIDE REQUIRED RESOURCES TO AN ELECTRONIC DEVICE AT A TARGET LOCATION TO PROVIDE A SERVICE

(71) Applicant: INTERNATIONAL BUSINESS MACHINES CORPORATION, Armonk, NY (US)

(72) Inventors: Jennifer M. Hatfield, Portland, OR (US); Jeremy R. Fox, Georgetown, TX (US); Tushar Agrawal, West Fargo, ND (US); Sarbajit K. Rakshit, Kolkata (IN)

(21) Appl. No.: 18/331,051

(22) Filed: Jun. 7, 2023

(51) Int. Cl. G08G 1/00; B60W 60/00

(52) U.S. Cl. CPC G08G 1/202; B60W 60/00253; G06Q 50/40

(57) ABSTRACT

Provided are a computer program product, system, and method for dispatching autonomous vehicles to provide required resources to an electronic device at a target location to provide a service. A determination is made of required resources consumed by an electronic device at the target location to provide a service to the target location. Additional resources needed to provide the required resources to the electronic device are determined in response to determining that the available resources at the target location are less than the required resources to provide the service. A determination is made of at least one autonomous vehicle available to dispatch to the target location to make the additional resources available to the electronic device. Commands are sent to the at least one autonomous vehicle to control the at least one autonomous vehicle to travel to the target location to provide the additional resources to the electronic device.

### BACKGROUND OF THE INVENTION

### 1. Field of the Invention

The present invention relates to a computer program product, system, and method for dispatching autonomous vehicles to provide required resources to an electronic device at a target location to provide a service.

### 2. Description of the Related Art

In order to provide a service to a remote location, the service provider may need to ensure that required resources are available at the remote location to provide the service. For instance, the service provider may want to communicate over a network to the remote location to perform the service, but there may not be sufficient network bandwidth or power available at the remote location to support the communication needed to perform the service.

There is a need in the art for improved techniques for delivering required resources to a remote location to be consumed by an electronic device at the remote location to provide a service at the remote location.

### SUMMARY

Provided are a computer program product, system, and method for dispatching autonomous vehicles to provide required resources to an electronic device at a target location to provide a service. A determination is made of required resources consumed by an electronic device at the target location to provide a service to the target location. A determination is further made whether available resources at the target location comprise the required resources. A determination is further made of additional resources needed to provide the required resources to the electronic device in response to determining that the available resources at the target location are less than the required resources. A determination is made of at least one autonomous vehicle available to dispatch to the target location to make the additional resources available to the electronic device to consume to provide the service to the target location. Commands are sent to the at least one autonomous vehicle to control the at least one autonomous vehicle to travel to the target location to provide the additional resources to the electronic device to consume.

### BRIEF DESCRIPTION OF THE DRAWINGS

FIG. 1 illustrates an embodiment of an environment in which autonomous vehicles may be dispatched to provide required resources to a target location.

FIG. 2 illustrates an embodiment of autonomous vehicle (AV) information.

FIG. 3 illustrates an embodiment of operations to dispatch autonomous vehicles to a target location to provide required resources to an electronic device to provide a service at the target location.

FIG. 4 illustrates an embodiment of operations to determine autonomous vehicles to deploy to a target location to provide required network bandwidth to the target location for communication with the electronic device to provide the service.

FIG. 5 illustrates an example of autonomous drones dispatched to engage with an emergency vehicle to provide required network bandwidth to provide medical services in the emergency vehicle.

FIG. 6 illustrates an example of how autonomous vehicles are arranged in a formation to provide wireless required resources to an emergency vehicle.

FIGS. 7 and 8 illustrate examples of formations of autonomous drones to provided network bandwidth and/or power to an emergency vehicle or location providing medical services.

FIG. 9 illustrates a computing environment in which the components of FIGS. 1 and 2 may be implemented.

### DETAILED DESCRIPTION

Situations may arise where network bandwidth and/or power need to be provided immediately to an electrical device at a remote location that consumes the resources to provide a service at the remote location. Described embodiments provide improved computer technology to determine the required resources, such as required network bandwidth and/or power, and determine autonomous vehicles available to be dispatched to the remote location to provide the required resources. Further, in certain embodiments, a determination may be made of a cell comprising a land area at which the required network bandwidth is available, and then the autonomous vehicles may be dispatched in a formation between the remote location needing the required bandwidth and the cell having the required bandwidth to connect the remote location to the cell with the required bandwidth.

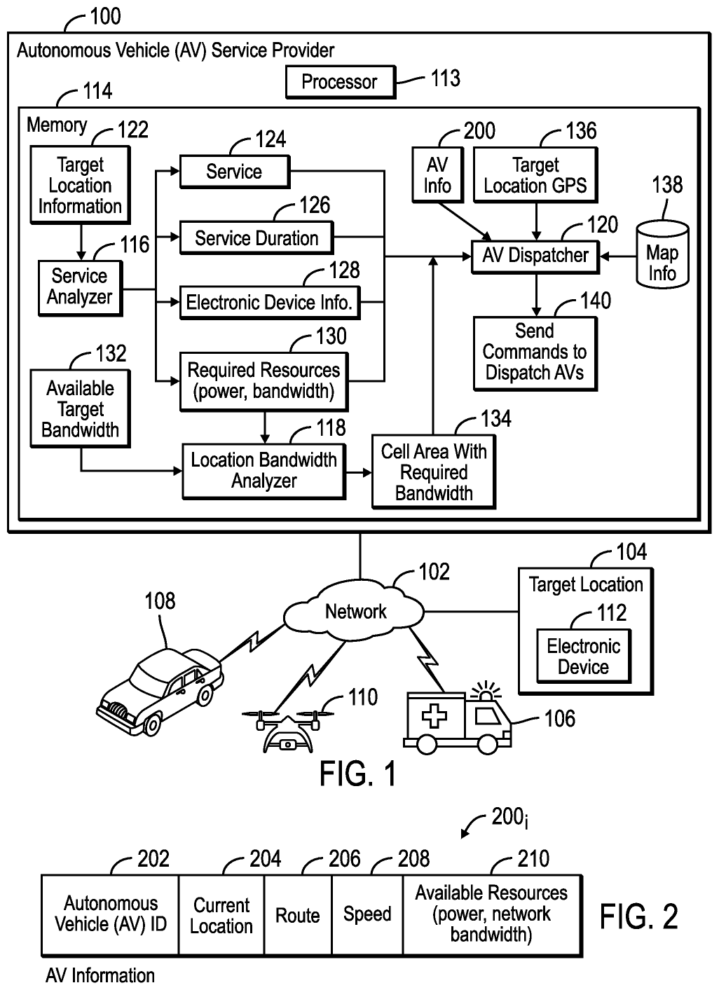

FIG. 1 illustrates an embodiment of an environment in which autonomous vehicles (“AVs”) may be dispatched to provide resources needed at a target location using an electronic device to consume the provided resources to provide a service at the target location. An AV service provider 100 is in communication over a network 102, such as a wireless network, e.g., cellular, Internet Wi-Fi, Internet satellite, etc., with a target location, which may comprise a fixed location 104 or a target vehicle 106, and various autonomous vehicles (AVs), including automobiles 108, aerial drones 110, etc., that are available to provide required resources to the target locations 104, 106. Other controlled autonomous vehicles that may be accessed by the AV service provider 100 to provide required resources to a target location 104, 106 may comprise, without limitation, autonomous boats, autonomous airplanes, autonomous submarines, autonomous helicopters, etc. The target location 104 and target vehicle 106 include an electronic device 112 to consume the resources from the AVs 108, 110 to provide a service at the target location 104, 106.

The AV service provider 100 includes a processor 113 and a memory 114 including programs executed by the processor 113, such as a service analyzer 116, a location bandwidth analyzer 118, and an AV dispatcher module (“AV dispatcher) 120. The service analyzer 116, which may comprise a machine learning model, receives target location information 122 from the target location 104, 106, such as conditions at the target location 104, 106 or a person at the target location 104, 106, such as a person injured or ill, and outputs information on a service 124 to provide at the target location 104, 106. The outputted information from the service analyzer 116 may include: an identifier of the service 124 provided for a service duration 126 at the target location 104, 106; electronic device information 128 on the electronic device 112 at the target location 104. 106; and required resources 130 the electronic device 128 consumes to provide the service 124, such as power, network bandwidth, etc.

If the required resources 130 comprise network bandwidth, then the location bandwidth analyzer 118 receives available target bandwidth 132 available at the target location 104, 106 and required resources 130, such as network bandwidth, from the service analyzer 116 and outputs cell coordinates 134 comprising a cell or land area, closest to the target location 104, 106, that provides the required network bandwidth 130.

In one embodiment, the target location information 122 may comprise medical findings of a patient in an ambulance 106 or target location 104 (e.g., medical site) and the service analyzer 116 may include a medical diagnosis engine to determine a medical diagnosis based on the received medical findings and determine a treatment as the service 124 to provide through the electronic device 112, such as a medical device, at the target location 104, 106. For instance, the required network bandwidth 130 may be needed for a doctor at a hospital or other location to communicate with the electronic device 112 comprising a medical device (e.g., medicine dispenser, remote surgical tools, body vital measurement devices, etc.) to provide the medical service to a patient at the target location 104, 106.

The AV dispatcher 120, which may comprise a machine learning model, receives the outputs 124, 126, 128, 130 from the service analyzer 116, the cell coordinates 134, if the required resources 130 comprise network bandwidth, AV information 200 on available AVs 108, 110, target location Global Positioning System (GPS) information 136, and map information 138 providing information on routes to the target location GPS 136. The AV dispatcher processes the received information to determine autonomous vehicles 108, 110 to dispatch to the target location 104, 106 and generate commands 140 to control the determined AVs 108, 110 to travel to the target location 104, 106.

In certain embodiments, the target location 104 may be located on water or underwater, and the autonomous vehicles may comprise autonomous water vessels, such as ships or submarines to extend network bandwidth across water or underwater to a target location on water or underwater, respectively.

The AVs 108, 110 may provide the required resources 130, such as power and network bandwidth, via wireless transmission to the target locations 104, 106. Alternatively, the power and/or network bandwidth resources may be provided via a wired connection from the AVs 108, 110 to the target location 104, 106.

The memory 114 may comprise suitable volatile or non-volatile memory devices.

Generally, program modules, such as the program components 116, 118, 120 may comprise routines, programs, objects, components, logic, data structures, and so on that perform particular tasks or implement particular abstract data types. The program components and hardware devices of the AV service provider 100 of FIG. 1 may be implemented in one or more computer systems, where if they are implemented in multiple computer systems, then the computer systems may communicate over a network.

In FIG. 1, the AV service provider 100 is shown as external to the target location 104, 106. In an alternative embodiment, the AV service provider 100 may be located within the target location 104, 106.

The program components 116, 118, 120 may be accessed by a processor from a memory to execute. Alternatively, some or all of the program components 116, 118, 120 may be implemented in separate hardware devices, such as Application Specific Integrated Circuit (ASIC) hardware devices.

The functions described as performed by the programs may be implemented as program code in fewer program modules than shown or implemented as program code throughout a greater number of program modules than shown.

In certain embodiments, programs 116, 118, and 120 may use machine learning and deep learning algorithms, such as decision tree learning, association rule learning, neural network, inductive programming logic, support vector machines, Bayesian network, Recurrent Neural Networks (RNN), Feedforward Neural Networks, Convolutional Neural Networks (CNN), Deep Convolutional Neural Networks (DCNNs), Generative Adversarial Network (GAN), etc. For artificial neural network program implementations, the neural network may be trained using backward propagation to adjust weights and biases at nodes in a hidden layer to produce their output based on the received inputs. In backward propagation used to train a neural network machine learning model, biases at nodes in the hidden layer are adjusted accordingly to produce the output having specified confidence levels based on the input parameters. The programs 116, 118, 120 may be trained to produce their output for product information and product recommendations, respectively, based on the inputs. Backward propagation may comprise an algorithm for supervised learning of artificial neural networks using gradient descent. Given an artificial neural network and an error function, the method may use gradient descent to find the parameters (coefficients) for the nodes in a neural network or function that minimizes a cost function measuring the difference or error between actual and predicted values for different parameters. The parameters are continually adjusted during gradient descent to minimize the error.

In backward propagation used to train a neural network machine learning model, such as programs 116, 118, 120, margin of errors are determined based on a difference of the calculated predictions and user rankings of the output. Biases (parameters) at nodes in the hidden layer are adjusted accordingly to minimize the margin of error of the error function.

In an alternative embodiment, the components 116, 118, 120 may be implemented not as a machine learning model, but implemented using a rules based system to determine the outputs from the inputs. The components 116, 118, 120 may further be implemented using an unsupervised machine learning model, or machine learning implemented in methods other than neural networks, such as multivariable linear regression models.

The network 102 may comprise the Internet, a Wide Area Network (WAN), wireless network, satellite network, cellular network, etc.

FIG. 2 illustrates an embodiment of the AV information 200; for one of the available AVs 108, 110, and includes: an AV identifier (ID) 202; a current location 204 of the AV 202; a route 206 the AV can take to reach the target location 106, 106; a speed 208 at which the AV is traveling; and available resources 210 at the AV, such as power and network bandwidth.

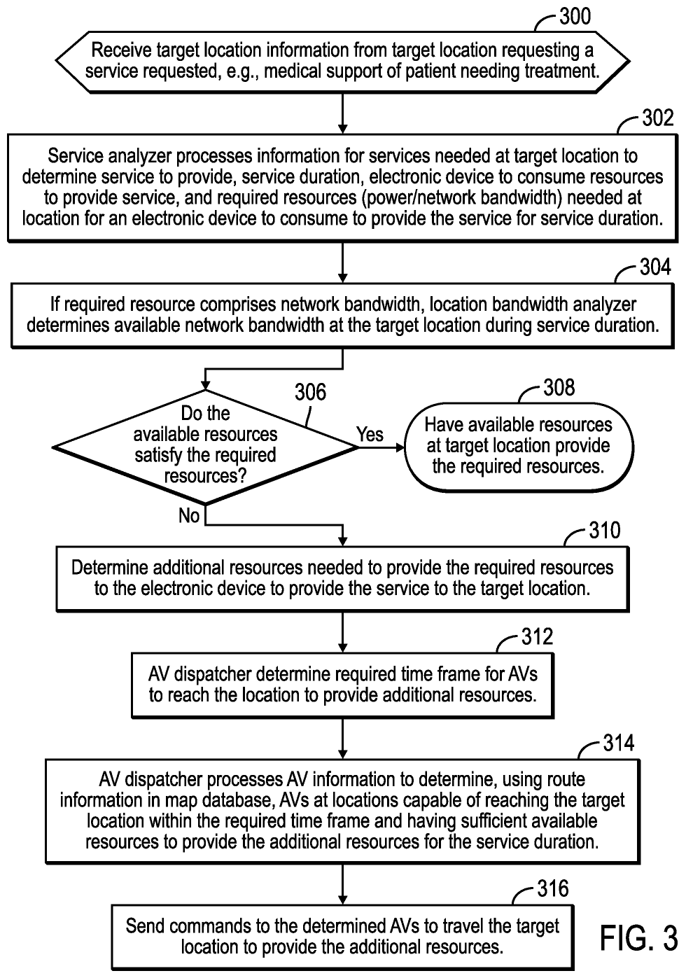

FIG. 3 illustrates an embodiment of operations performed by the AV service provider 100 to determine resources needed to provide a service to a target location 104, 106. Upon receiving (at block 300) target location information 122 from target location 104. 106 requesting a service, e.g., medical support of patient needing treatment, the service analyzer 116 processes (at block 302) the target location information 122 for services needed at the target location 104, 106 to determine a service 124 to provide, service duration 126, electronic device 128 to consume resources to provide the service 124, and required resources 130, e.g., power/network bandwidth, needed at the target location 104, 106 for the electronic device 128 to consume to provide the service 124 for the service duration 126. If the required resource 130 comprises network bandwidth, then the location bandwidth analyzer 118 determines (at block 304) available network bandwidth at the target location 104, 106 during the service duration 126. The location bandwidth analyzer 118 may access real-time information from an Internet Service Provider for the target location 104, 106 to determine current available network bandwidth at the target location 104, 106.

If (at block 306) the available resources satisfy the required resources 130, then control ends (at block 308) to have the available resources at the target location 104, 106 provide the required resources to the electronic device 112. If (at block 306) the available resources do not satisfy the required resources 130, then the AV dispatcher 120, or other component, determines (at block 312) additional resources needed to provide the required resources to the electronic device 112 to provide the service to the target location 104, 106. The AV dispatcher 120 processes (at block 314) AV information 200, target location GPS 136, map information 138 and output 124, 126, 128, 130 from the service analyzer 116 to determine, using route information in the map information 138, AVs 108, 110 at locations capable of reaching the target location within a required time frame and having sufficient available resources to provide the additional resources to the electronic device 112 at the target location 104, 106 for the service duration 126. The AV dispatcher 120 sends (at block 316) commands to the determined AVs 108, 110 to travel to the target location 104, 106, such as via air or roads, to provide the additional resources.

With the embodiment of FIG. 3, the AV service provider 100 determines additional resources required at the target location 104, 106 and the AVs 108, 110 to dispatch to the target location to provide the required resources to the electronic device 112 at the target location 104 to perform the needed service. Described embodiments, consider not only the resources required at the target location 104, but also consider AV information 200, target location GPS 136, and map information 138 on the route the AVs 108, 110 can take to reach the target location to dispatch the closest AVs 108 of the appropriate type and having sufficient of the available resources needed by the electronic device 112 to provide the required services.

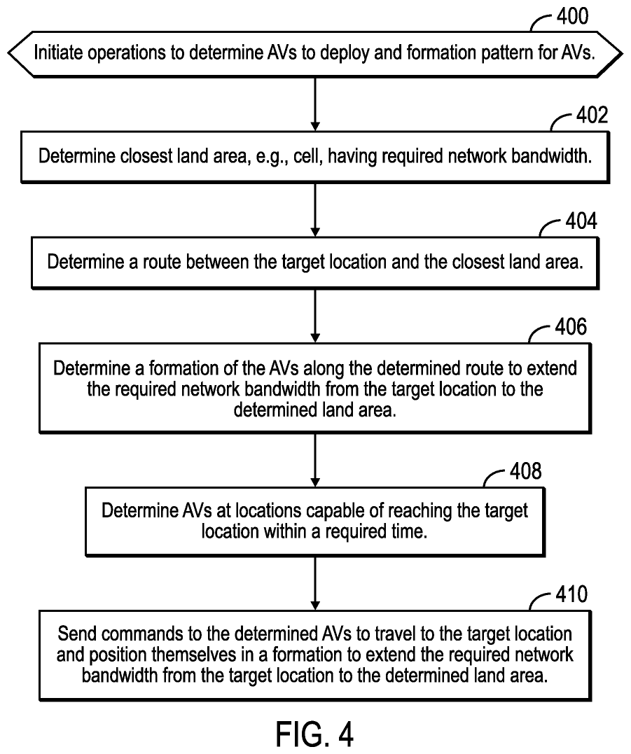

FIG. 4 illustrates an embodiment of operations performed at blocks 314 and 316 of FIG. 3 to determine AVs 108, 110 to provide network bandwidth from target location 104, 106 to a cell area having the required network bandwidth 130 and send commands to the determined AVs 108, 110 to engage in a formation to extend the required network bandwidth from the cell area to the target location 104, 106. Upon initiating (at block 400) operations to determine AVs 108, 110 to provide the required network bandwidth 130, the location bandwidth analyzer 118 determines (at block 402) a land area 134, e.g., cell coordinates, having required network band 130. The AV dispatcher 120 determines (at block 404), from the map information 138 and the target location GPS 136, a route from the cell coordinates 134 to the target location GPS 136. The AV dispatcher 120 determines (at block 406) a formation of the AVs along the determined route to extend the required network bandwidth 130 from the target location 104, 106 to the determined cell coordinates 134. The formation may comprise a line of spaced apart AVs 106, 108, e.g., drones or motor vehicles or a mesh formation of AVs 108, 110.

A determination is made (at block 408) of the AVs at locations capable of reaching the target location 104, 106 within a required time at which the service needs to be initiated, such as providing medical services to an injured or ill patient. The AV dispatcher 120 sends (at block 410) commands to the determined AVs 108, 110 to dispatch the AVs 108, 110 to the target location 104, 106 and position themselves in the formation to extend the required network bandwidth 130 from the target location 104. 106 to the determined cell area 134.

With the embodiment of FIG. 4, the AV dispatcher 120 determines a formation of AVs 108, 110 to extend network bandwidth from the target location 104, 106 to the cell area 134 having the required network bandwidth 130 to provide the electronic device 112 sufficient bandwidth to provide the service 124 at the target location 104, 106.

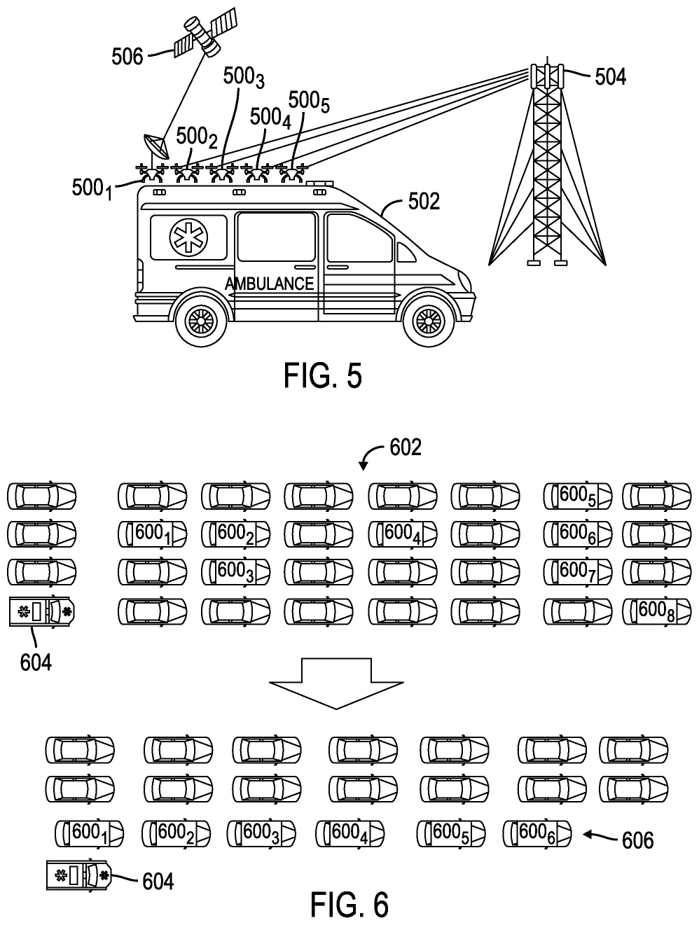

FIG. 5 illustrates one embodiment where the AVs 110 comprise drones 500₁, 500₂ . . . 500₅ that land on a target emergency vehicle 502 and remain affixed to the vehicle 502 to provide additional network bandwidth to the emergency vehicle 502. For instance, drones 500₂ . . . 500₅ have embedded Subscriber Identity Modules (eSIMs) to connect to a cellular tower 504 to create a parallel cellular network to increase bandwidth. Drone 500₁ provides a network connection to a satellite 506 to provide redundant bandwidth paths in the event a critical procedure is being performed in the ambulance 502. In this way, least one of the autonomous vehicles, e.g., 500₁, at the emergency vehicle 502, provides additional network bandwidth between the ambulance 502, including an electronic device 112 therein, and one network transmission station 506 and at least one of the autonomous vehicles, e.g., 500₂ . . . 500₅, provides additional network bandwidth between the ambulance 502 and another network transmission station 504.

FIG. 6 illustrates an embodiment where the AVs 108 capable of providing the required resource comprise autonomous automobiles 600₁, 600₂ . . . 600₈ in traffic 602 including a target ambulance 604. The AVs 600₁, 600₂ . . . 600₆ are dispatched to form a line formation (line) 606 to provide the required resources 130, e.g., power and/or network bandwidth, to the ambulance 604 travelling along the line 606 of autonomous automobiles. In this way, the AVs 600₁, 600₂ are dispatched to the target 604 vehicle while the target vehicle 604 is in transit to provide the required network bandwidth. The AV dispatcher 102 sends commands to the AVs 600₁, 600₂ to position them in formation 606 to provide the required network bandwidth to the electronic device in the target vehicle while in transit to the destination location.

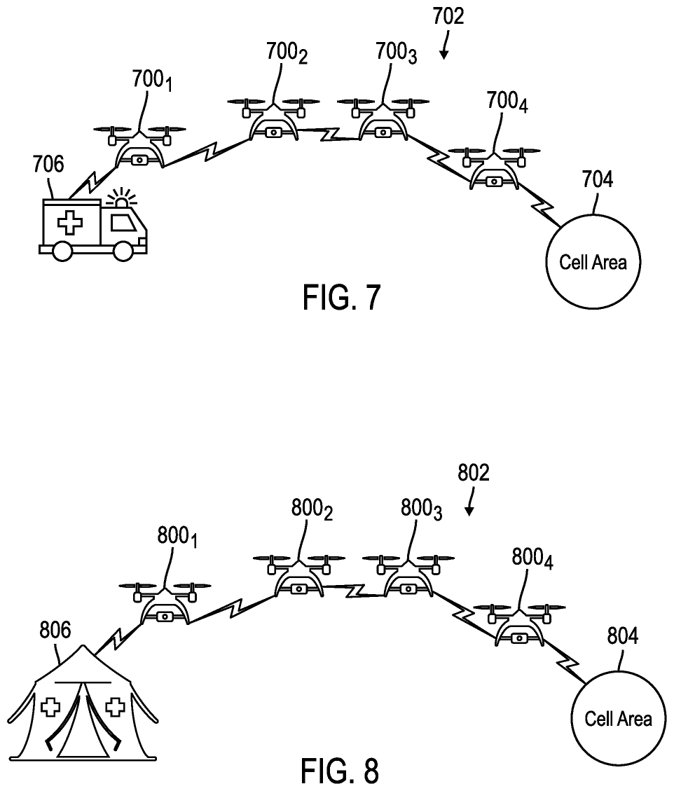

FIG. 7 illustrates an embodiment where the AVs 110 comprise aerial drones 700₁, 700₂, 700₃, 700₄ that are dispatched by the AV dispatcher 120 in a formation 702 to extend the required network bandwidth 130 from a cell area 704 providing the required network bandwidth 130 to an ambulance 706. With the embodiment of FIG. 7, the aerial drones 700₁, 700₂, 700₃, 700₄ may provide network bandwidth and/or power to an ambulance 706 to allow control of medical equipment to treat a patient needing triage enroute to a hospital or to provide mobile medical services in non-emergency situations where additional bandwidth is required.

FIG. 8 illustrates an embodiment where the AVs 110 comprise aerial drones 800₁, 800₂, 800₃, 800₄ that are dispatched by the AV dispatcher 120 in a formation 802 to extend the required network bandwidth 130 from a cell area 804 providing the required network bandwidth 130 to mobile medical unit 806, such as a mobile surgical hospital. With the embodiment of FIG. 8, the aerial drones 800₁, 800₂, 800₃, 800₄ may provide bandwidth and/or power to the remote medical unit 806 that may be set-up ad hoc to provide emergency services at a disaster site where there is very limited network bandwidth.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

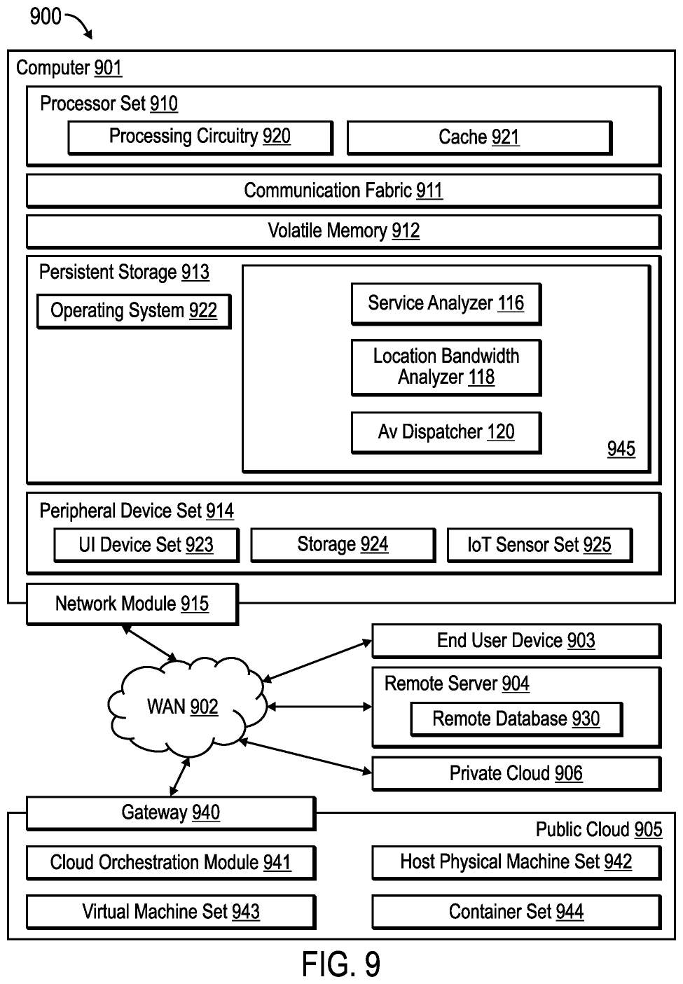

In FIG. 9, computing environment 900 contains an example of an environment for the execution of at least some of the computer code involved in performing the inventive methods. Block 945 includes the service analyzer 116, location bandwidth analyzer 118, and AV dispatcher 120 to perform the inventive methods. In addition to block 945, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 945, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 945 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in block 945 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on. The EUD 903 may comprise the target locations 104, 106 to which the service and required resources are provided. The EUD 903 may further include the AVs 108, 110.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The letter designators, such as i, is used to designate a number of instances of an element may indicate a variable number of instances of that element when used with the same or different elements.

The terms “an embodiment”, “embodiment”. “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for providing resources to a target location, wherein the computer program product comprises a computer readable storage medium having program instructions embodied therewith that when executed cause operations, the operations comprising:
determining required resources consumed by an electronic device at the target location to provide a service to the target location;
determining whether available resources at the target location comprise the required resources;
determining additional resources needed to provide the required resources to the electronic device in response to determining that the available resources at the target location are less than the required resources;
determining at least one autonomous vehicle available to dispatch to the target location to make the additional resources available to the electronic device to consume to provide the service to the target location; and
sending commands to the at least one autonomous vehicle to control the at least one autonomous vehicle to travel to the target location to provide the additional resources to the electronic device to consume.

2. The computer program product of claim 1, wherein the required resources comprise required power, the available resources comprise available power, and the additional resources comprise additional power, wherein the additional power comprises the required power less the available power at the target location, wherein the at least one autonomous vehicle travels to the target location to provide the additional power via wireless transmission to the electronic device to provide the service at the target location.

3. The computer program product of claim 1, wherein the required resources comprise required network bandwidth, wherein the available resources comprise available network bandwidth at the target location provides to the electronic device, and the additional resources comprise additional network bandwidth needed to provide the required network bandwidth to the target location, wherein the at least one autonomous vehicle provides the additional network bandwidth via wireless transmission with the electronic device at the target location to provide the service.

4. The computer program product of claim 3, wherein the determining the at least one available autonomous vehicle comprises determining autonomous vehicles that can be positioned in a formation along a route from the target location to a cell area having the required network bandwidth to connect the target location to the cell area, wherein the sending the commands comprises sending the commands to the determined autonomous vehicles to control the autonomous vehicles to be arranged in the formation to provide the required network bandwidth between the electronic device at the target location, through the autonomous vehicles, to the cell area.

5. The computer program product of claim 3, wherein the determining the at least one autonomous vehicle comprises determining autonomous vehicles to dispatch to the target location, wherein least one of the autonomous vehicles at the target location provide the additional network bandwidth between the electronic device and a first network transmission station and wherein at least one of the determined autonomous vehicles at the target location provides the additional network bandwidth between the electronic device and a second network transmission station.

6. The computer program product of claim 3, wherein the target location comprises a target vehicle including the electronic device in transit to a destination location, wherein the determining the at least one autonomous vehicle comprises determining autonomous vehicles to dispatch to the target vehicle while in transit to provide the required network bandwidth, and wherein the sending the commands comprises sending the commands to the determined autonomous vehicles to provide the required network bandwidth to the electronic device in the target vehicle while in transit to the destination location.

7. The computer program product of claim 6, wherein the operations further comprise:
receiving information on a route the target vehicle is taking in transit and a current speed of the target vehicle, wherein the commands direct the determined autonomous vehicles to be positioned in a formation and travel at a speed to remain in the formation with respect to the target vehicle while the target vehicle is in transit at the current speed to provide the required network bandwidth to the target vehicle.

8. The computer program product of claim 6, wherein the autonomous vehicles comprise drones, wherein the operations further comprise:
receiving information on a route the target vehicle is taking in transit and a current speed of the target vehicle, wherein the commands direct the drones to land on the target vehicle and remain coupled to target the vehicle to provide the required network bandwidth while the target vehicle is in transit.

9. The computer program product of claim 1, wherein the operations further comprise:
receiving target location information to provide the service to the target location;
determining from the target location information the service to provide, a service duration of the service, and the required resources for the electronic device to provide the service for the service duration; and
determining, from the service, the service duration, the electronic device, and the required resources, the at least one autonomous vehicle to travel to the target location to provide the required resources to implement the service.

10. The computer program product of claim 3, wherein the target location comprises an emergency vehicle and the electronic device in the emergency vehicle comprises a medical treatment device that uses the required network bandwidth to provide emergency care to a patient in the emergency vehicle, wherein the operations further comprise:
receiving measured medical findings of a patient in the emergency vehicle; and
using a medical diagnosis engine to determine a medical diagnosis and emergency care to provide to the patient using the medical treatment device, wherein the determining the required network bandwidth comprises determining network bandwidth the medical treatment device requires to communicate with a health care provider at a remote location to deliver the emergency care to the patient.

11. The computer program product of claim 1, wherein the at least one autonomous vehicle comprises at least one of an aerial drone, a motor vehicle, a boat, a submarine, a helicopter, and an airplane.

12. A system for providing resources to a target location, comprising:
a processor; and
a computer readable storage medium having program instructions embodied therewith that when executed by the processor causes operations, the operations comprising:
determining required resources consumed by an electronic device at the target location to provide a service to the target location;
determining whether available resources at the target location comprise the required resources;
determining additional resources needed to provide the required resources to the electronic device in response to determining that the available resources at the target location are less than the required resources;
determining at least one autonomous vehicle available to dispatch to the target location to make the additional resources available to the electronic device to consume to provide the service to the target location; and
sending commands to the at least one autonomous vehicle to control the at least one autonomous vehicle to travel to the target location to provide the additional resources to the electronic device to consume.

13. The system of claim 12, wherein the required resources comprise required network bandwidth, wherein the available resources comprise available network bandwidth at the target location provides to the electronic device, and the additional resources comprise additional network bandwidth needed to provide the required network bandwidth to the target location, wherein the at least one autonomous vehicle provides the additional network bandwidth via wireless transmission with the electronic device at the target location to provide the service.

14. The system of claim 13, wherein the determining the at least one available autonomous vehicle comprises determining autonomous vehicles that can be positioned in a formation along a route from the target location to a cell area having the required network bandwidth to connect the target location to the cell area, wherein the sending the commands comprises sending the commands to the determined autonomous vehicles to control the autonomous vehicles to be arranged in the formation to provide the required network bandwidth between the electronic device at the target location, through the autonomous vehicles, to the cell area.

15. The system of claim 13, wherein the target location comprises a target vehicle including the electronic device in transit to a destination location, wherein the determining the at least one autonomous vehicle comprises determining autonomous vehicles to dispatch to the target vehicle while in transit to provide the required network bandwidth, and wherein the sending the commands comprises sending the commands to the determined autonomous vehicles to provide the required network bandwidth to the electronic device in the target vehicle while in transit to the destination location.

16. The system of claim 13, wherein the target location comprises an emergency vehicle and the electronic device in the emergency vehicle comprises a medical treatment device that uses the required network bandwidth to provide emergency care to a patient in the emergency vehicle, wherein the operations further comprise:
receiving measured medical findings of a patient in the emergency vehicle; and
using a medical diagnosis engine to determine a medical diagnosis and emergency care to provide to the patient using the medical treatment device, wherein the determining the required network bandwidth comprises determining network bandwidth the medical treatment device requires to communicate with a health care provider at a remote location to deliver the emergency care to the patient.

17. A method for providing resources to a target location, comprising:
determining required resources consumed by an electronic device at the target location to provide a service to the target location;
determining whether available resources at the target location comprise the required resources;
determining additional resources needed to provide the required resources to the electronic device in response to determining that the available resources at the target location are less than the required resources;
determining at least one autonomous vehicle available to dispatch to the target location to make the additional resources available to the electronic device to consume to provide the service to the target location; and
sending commands to the at least one autonomous vehicle to control the at least one autonomous vehicle to travel to the target location to provide the additional resources to the electronic device to consume.

18. The method of claim 17, wherein the required resources comprise required network bandwidth, wherein the available resources comprise available network bandwidth at the target location provides to the electronic device, and the additional resources comprise additional network bandwidth needed to provide the required network bandwidth to the target location, wherein the at least one autonomous vehicle provides the additional network bandwidth via wireless transmission with the electronic device at the target location to provide the service.

19. The method of claim 18, wherein the determining the at least one available autonomous vehicle comprises determining autonomous vehicles that can be positioned in a formation along a route from the target location to a cell area having the required network bandwidth to connect the target location to the cell area, wherein the sending the commands comprises sending the commands to the determined autonomous vehicles to control the autonomous vehicles to be arranged in the formation to provide the required network bandwidth between the electronic device at the target location, through the autonomous vehicles, to the cell area.

20. The method of claim 18, wherein the target location comprises an emergency vehicle and the electronic device in the emergency vehicle comprises a medical treatment device that uses the required network bandwidth to provide emergency care to a patient in the emergency vehicle, wherein the operations further comprise:
receiving measured medical findings of a patient in the emergency vehicle; and
using a medical diagnosis engine to determine a medical diagnosis and emergency care to provide to the patient using the medical treatment device, wherein the determining the required network bandwidth comprises determining network bandwidth the medical treatment device requires to communicate with a health care provider at a remote location to deliver the emergency care to the patient.
